(19) United States
(12) Patent Application Publication
(10) Pub. No.: US 2026/0093461 A1
(43) Pub. Date: Apr. 2, 2026

(54) SYSTEMS AND METHODS FOR ENHANCING PROVISION OF INFORMATION TECHNOLOGY SUPPORT SERVICES

(71) Applicant: ConnectWise, LLC, Tampa, FL (US)

(72) Inventors: Jason Marc Short, Tampa, FL (US); Jacob Edward Turpin, Tampa, FL (US); Ameer Karim, Tampa, FL (US); Raghu Ram Bongula, Tampa, FL (US)

(21) Appl. No.: 19/162,828

(22) PCT Filed: Feb. 9, 2024
(86) PCT No.: PCT/US2024/015215

§ 371 Date: Sep. 5, 2025

Related U.S. Application Data
(60) Provisional application No. 63/484,375, filed on Feb. 10, 2023.

(51) Int. Cl. G06F 8/30; H04L 67/306

(52) U.S. Cl. CPC G06F 8/31; H04L 67/306

(57) ABSTRACT

In some embodiments, systems and methods described here provide the ability to automatically generate scripts and optimize them for execution on a remotely managed endpoint. In some embodiments, a method includes receiving a request, optionally augmented, at a user interface of a managed service provider. The request is a request for assistive service implementing the managed service provider. The method further includes selecting generative model to respond to the request. The generative model is selected based on information of a profile of the managed service provider. The method further includes receiving, from the selected generative model, a response to the request. The response provides the assistive service implementing the managed service provider.

### CROSS-REFERENCE TO RELATED APPLICATIONS

This application claims the benefit of priority to U.S. Provisional No. 63/484,375, filed on Feb. 10, 2023; the entire contents of each of which is hereby incorporated by reference.

### BACKGROUND

A managed service provider (MSP) provides a range of Information Technology (IT) services and support to businesses, typically on a subscription basis, to help organizations manage and maintain their IT infrastructure, including hardware, software, networks, and data.

### BRIEF SUMMARY

An MSP's role can vary depending on the client's needs. Common services offered by MSPs include: network and infrastructure management, (e.g., monitoring and maintaining hardware, such as servers, switches, firewalls, and the software and systems running on them); cloud services to help businesses move their IT infrastructure to the cloud, manage and provide ongoing support and maintenance for cloud-based applications and services; data backup and recovery services to help businesses backup their data and provide quick and easy recovery in the event of a disaster; security services to help businesses secure their networks and data from threats such as cyberattacks and data breaches and help desk support, providing technical support to users, answering questions and resolving issues with hardware, software, and systems.

Managed Service Providers (MSPs) face several challenges in delivering high-quality services to their clients. Some of these challenges include: cybersecurity threats, which require MSPs to stay on top of the latest security trends and technologies to keep their clients' data and systems safe; technical challenges, which require MSPs to have a deep understanding of the technologies they manage, including hardware, software, and cloud solutions so that they can diagnose and resolve technical problems quickly and efficiently; scalability of their services and resources to meet increased demand; and staffing retention in the face of demand for skilled IT professionals.

In some examples, MSPs use scripts to help manage endpoint computing devices. In some examples, scripts are a predefined set of commands. Scripts may include commands, functions, variables, loops, and conditional statements. One example of a scripting language is PowerShell; however other scripting languages can be used. A PowerShell script is a set of commands written in the PowerShell scripting language that can be executed as a single unit to perform a specific task or automate a series of tasks. PowerShell scripts can be run from the Windows command prompt or by using the PowerShell integrated scripting environment (ISE). These scripts can be used for tasks such as managing and automating administrative tasks, managing and automating servers, and managing and automating applications and services.

The systems and methods described in this document allows an MSP to meet at least some of the challenges described above by providing the ability to generate scripts and optimize them for execution on a remotely managed endpoint. The systems and methods also allow the automatically generated scripts to be evaluated for utility and efficacy. The systems and methods can further be used to provide plain language summary or description of provided scripts.

In some embodiments, a method includes receiving, at a user interface of a managed service provider, a request for an assistive service. The method further includes accessing from a memory element a profile associated with the managed service provider. The method further includes selecting, based on the accessed profile, a generative model to respond to the request. The method further includes augmenting, based on the accessed profile, the received request. The method further includes transmitting, via a network, the augmented request to the selected generative model. The method further includes receiving, from the selected generative model, a response to the request providing the assistive service.

In some embodiments, augmenting the request includes one or more of adding, removing, and modifying a term of the request based on profile information of a user of the managed service provider.

In some embodiments, the accessed profile includes one or more of an identification of the user entering the request, an identification of an enterprise associated with the user, an identification of hardware deployed by the enterprise, an identification of software deployed by the enterprise, an identification of operation systems deployed by the enterprise, an identification of firmware deployed by the enterprise, and an identification of software the user is using to make the request.

In some embodiments, the method includes gathering the accessed profile from a profile database.

In some embodiments, the method includes classifying systems managed by the managed service provider into a first group of systems and a second group of systems, the classification based on the first group of systems having a first common hardware or software attribute and the second group of systems having a second common hardware or software attribute.

In some embodiments, the method includes receiving a selected script language. The selected script language is included in the request in a manner that the generative model returns an output in the selected script language.

In some embodiments, the method includes transmitting the augmented request to the selected generative model over a network. The method further includes receiving a script, as the result, from the generative AI model in response to the request over the network. The method further includes presenting the received script in the user interface. The method further includes receiving feedback from a user via the user interface. The method further includes, upon feedback indicating the augmented request should be modified, generating a tuned augmented request based on the feedback.

In some embodiments, the method includes remotely executing instructions associated with the response at a remotely managed endpoint associated with the managed service provider.

In some embodiments, a system includes a computing node comprising a computer readable storage medium having program instructions embodied therewith. The program instructions executable by a processor of the computing node to cause the processor to perform a method comprising receiving, at a user interface of a managed service provider, a request for an assistive service. The program instructions further cause the processor to access from a memory element a profile associated with the managed service provider. The program instructions further cause the processor to select, based on the accessed profile, a generative model to respond to the request. The program instructions further cause the processor to augment, based on the accessed profile, the received request. The program instructions further cause the processor to transmit, via a network, the augmented request to the selected generative model. The program instructions further cause the processor to receive, from the selected generative model, a response to the request providing the assistive service.

In some embodiments, a computer program product includes a computer readable storage medium having program instructions embodied therewith. The program instructions executable by a server to cause the server to perform a method comprising receiving, at a user interface of a managed service provider, a request for an assistive service. The program instructions further cause the server to access from a memory element a profile associated with the managed service provider. The program instructions further cause the server to select, based on the accessed profile, a generative model to respond to the request. The program instructions further cause the server to augment, based on the accessed profile, the received request. The program instructions further cause the server to transmitting, via a network, the augmented request to the selected generative model. The program instructions further cause the server to receive, from the selected generative model, a response to the request providing the assistive service.

In some embodiments, the method, system, and computer program product can perform any of the above described steps in combination.

### BRIEF DESCRIPTION OF THE SEVERAL VIEWS OF THE DRAWINGS

The details of one or more embodiments of the subject matter described in this specification are set forth in the accompanying drawings and the description below. Other features, aspects, and advantages of the subject matter will become apparent from the description, the drawings, and the claims.

FIG. 1 is a block diagram of one embodiment of a system for enhancing the provision of information technology support services.

FIGS. 2A-D are a flow diagram of embodiments of methods for enhancing the provision of information technology support services.

FIG. 3 is a diagram illustrating some embodiments of user interface employed by the present disclosure.

FIG. 4 depicts a computing node according to an embodiment of the present disclosure.

### DETAILED DESCRIPTION

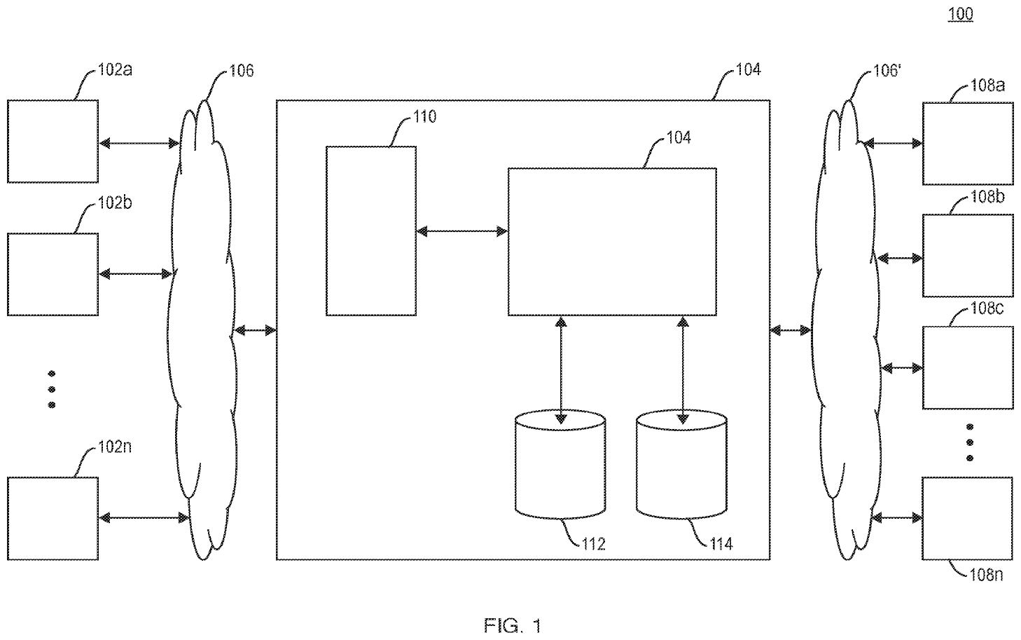

Referring now to FIG. 1, and in brief overview, a block diagram of one embodiment of a system for enhancing the provision of information technology support services, such as a managed service provider (MSP) or remove monitoring and management (RMM) solution, is shown. As shown in FIG. 1, MSP resources 102a, 102b, 102n communicate with an assistive service 104 over a first network 106. Assistive service 104 communicates with one or more generative artificial intelligence (AI) models 108a, 108b, 108c, 108n over second network 106′. In some embodiments, first network 106 and second network 106′ may be the same network. As shown in FIG. 1, assistive service 104 includes an authentication/authorization service 110, a profile database 112, and a telemetry database 114.

Still referring to FIG. 1, and in more detail, MSP resources 102 communicate with assistive service 104 over first network 106. MSP resources 102 may refer to individual employees of the MSP. In some embodiments, MSP resources may refer to platforms that help MSPs manage IT processes. Examples of such platforms include Automate, Manage, PSA, CPQ, Control, R1VIM, BCDR, ITBoost, BrightGauge, Cybersecurity Management, SIEM Network Threat Detection and ConnectWise MDR with Bitdefender, all of which are manufactured by ConnectWise, LLC of Tampa, Florida. In some embodiments, MSP resource 102 can provide an interface into which an IT professional can enter a help request, e.g., “optimize for battery life.”

In some embodiments, MSP resources 102 communicate with assistive service 104 using the representational state transfer (REST) API protocol. In other embodiments, MSP resources may communicate with assistive service 104 using the GraphQL API, gRPC, SOAP, Thrift or Falcor protocols. The request sent by MSP resource 102 includes a prompt, such as identifying the purpose of the requested shell script to be generated. In some embodiments, the prompt may be a request to generate a plain text summary for a script. The request may also include profile information, such as an identification of the IT professional making the request, an identification of the company with which the IT professional is affiliated, an identification of hardware platforms used by the company, an identification of software platforms (e.g., operating systems, software suites, etc.) used by the company, or the software platform the IT professional is using to make the request.

In some embodiments, the profile information from the profile database 112 can be used by the assistive service 104 to modify the request sent to the generative AI mode. For example, the assistive service 104 could analyze a request such as “Optimize systems for performance,” analyze the systems deployed by the enterprise using the MSP, and after determining all of the systems are running Windows 10, modify the request to state “Optimize Windows 10 Systems for performance.” In another example, the assistive service could analyze the same request, and after determining all of the systems have at least one same hardware commonality, modify the request to include that commonality. For example, if all of the systems use 32 gigabytes of random-access memory (RAM), the request may be modified to state “Optimize systems that have 32 gigabytes of RAM for performance.” While memory is used as an example, other hardware specifications can be used such as processor type, processor speed (e.g., Gigahertz (GHz), Operations per second (OPS), floating-point operations per second (FLOPS), etc.), bus speed, video card memory, video card processor speed, video card processor type, network type, network speed, network connection type (e.g., wired ethernet, Wi-Fi, 5G, etc.), or other hardware specifications.

In some embodiments, the assistive service 104 can classify the deployed systems into two or more groups of hardware or software systems. For example, the assistive service 104 could analyze a request such as “Optimize systems for performance,” analyze the systems deployed by the enterprise using the MSP, and after determining a first group of the systems are running Windows 10 and a second group of the systems are running Windows 11. The assistive service 104 can then generate two modified requests. A first modified request for the first group can state “Optimize Windows 10 Systems for performance,” and a second modified request for the second group can state “Optimize Windows 11 Systems for performance.” The two requests are issued separately to one or more generative AI models 108, and the response is displayed in proximity to their respective modified request.

In another example, the assistive service 104 could analyze the same request, and determine a first group of the systems have a first hardware commonality and the second group of the systems have a second hardware commonality. The assistive service 104 can generate two modified requests, one for the first group of systems and one for the second group of systems. For example, if the first group of systems use 32 gigabytes of random-access memory (RAM), the request for the first group may be modified to state “Optimize systems that have 32 gigabytes of RAM for performance.” If the second group of systems uses 64 gigabytes of RAM, the request for the second group may be modified to state “Optimize systems that have 64 gigabytes of RAM for performance.” While memory is used as an example, other hardware specifications can be used such as processor type, processor speed (e.g., Gigahertz (GHz), Operations per second (OPS), floating-point operations per second (FLOPS), etc.), bus speed, video card memory, video card processor speed, video card processor type, network type, network speed, network connection type (e.g., wired ethernet, Wi-Fi, 5G, etc.), or other hardware specifications. The two requests are issued separately to one or more generative AI models 108, and the response is displayed in proximity to their respective modified request.

First network 106 can include a local-area network (LAN), such as a company Intranet, a metropolitan area network (MAN), or a wide area network (WAN), such as the Internet or the World Wide Web. In some embodiments, there are multiple networks between the MSP resources 102 and assistive service 104. In one of these embodiments, the network may be a public network, a private network, or may include combinations of public and private networks.

First network 106 may be any type or form of network and may include one or more of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, network 106 may include a wireless link, such as an infrared channel or satellite band. The topology of network 106 may include a bus, star, or ring network topology. The network may include mobile telephone networks utilizing any protocol or protocols used to communicate among mobile devices, including advanced mobile phone protocol (“AMPS”), time division multiple access (“TDMA”), code-division multiple access (“CDMA”), global system for mobile communication (“GSM”), general packet radio services (“GPRS”) or universal mobile telecommunications system (“UIMTS”). In some embodiments, different types of data may be transmitted via different protocols. In other embodiments, the same types of data may be transmitted via different protocols.

Still referring to FIG. 1, assistive service 104 receives requests from MSP resources 102. In some embodiments, an authentication/authorization service 110 can authenticate requests. In some embodiments, authentication/authorization service 110 authenticates the request from credentials supplied in the profile information associated with the request. In some embodiments, the request may be digitally signed by the MSP resource prior to transmission using a private cryptographic key associated with the MSP resource 102. In some embodiments, assistive service 104 prompts the MSP resource 102 for authentication credentials after receiving the request.

In some embodiments, assistive service 104 accesses the profile database 112 using profile information from the request. In some embodiments, the assistive service selects one of several generative AI models 108 to which to send the prompt based on information in the profile database 112. In some embodiments, the prompt is augmented using information from the profile database 112. For example, the assistive service may 104 may receive a prompt to “optimize for battery life” accompanied by an identifier associated with a specific MSP. The assistive service 104 may use the MSP identifier included in the request to access the profile database 112 and determine that the prompt should be embedded in a “script” to elicit a better response from the selected generative AI model 108. Thus, “optimize for battery life” may be converted into “Provide a script to optimize for battery life and comment the script.”

Assistive service 104 transmits the prompt via second network 106′ to a selected one of several available generative AI models 108 for processing. Examples of available generative AI models include the Transformers Library, manufactured by Hugging Face, Inc. of New York, NY, ChatGPT manufactured by OpenAI of San Francisco, California, DeepMind, manufactured by Google, LLC of Mountain View, California and Azure Al, manufactured by Microsoft Corporation of Redmond, Washington. Assistive service 104 receives the requested script from the selected generative AI model 108 and transmits the script to the MSP resource 102.

In some embodiments, telemetry database 114 stores information about the request prompt, the requesting account, the tuning used, and the response. Therefore, the telemetry database 114 provides a mechanism to allow a comparison between the response from the generative AI and the response's actual performance in the MSP. The telemetry database 114 and the data contained therein is then used for tuning analysis, A/B testing between tuning options and AI engines, and cost analysis on usage by product/partner.

In some embodiments, the user of the MSP can then review and approve the script. Once approved, the user can deploy the script to a remotely managed endpoint (e.g., workstation, server, etc.). In some embodiments, deploying the script includes remotely executing instructions with the response (e.g., script) at the remotely managed endpoint associated with the managed service provider.

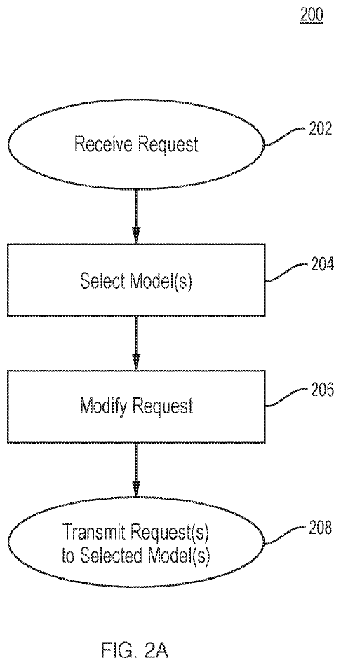

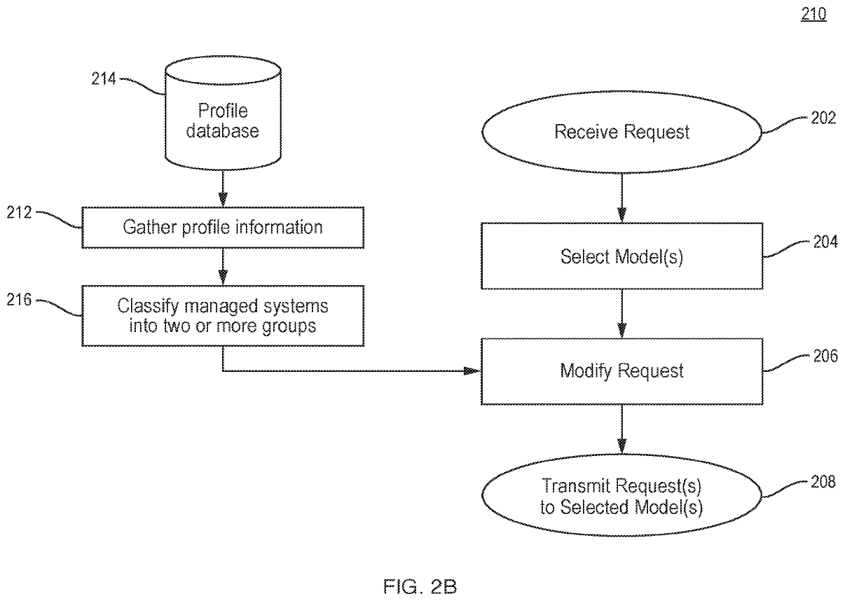

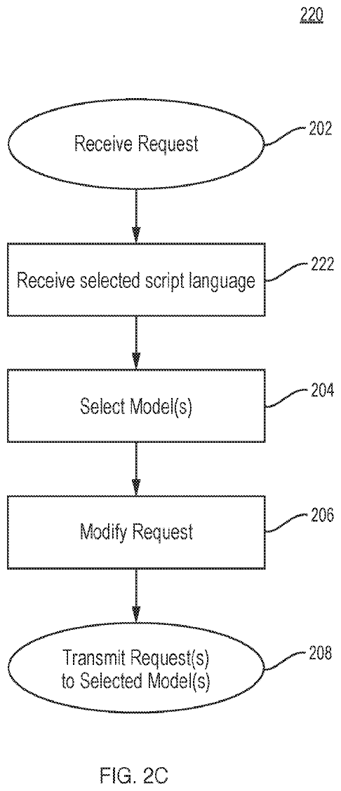

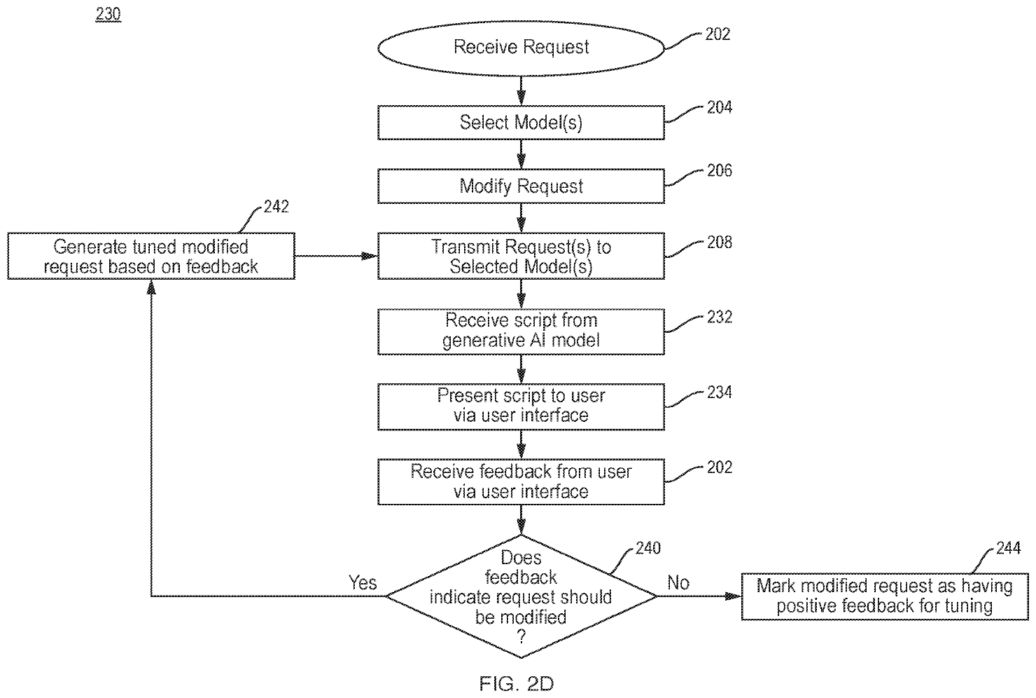

FIG. 2A is a flow diagram 200 illustrating example embodiments of a method for enhancing the provision of information technology support services. The method includes receiving a request 202, selecting a generative AI model 204, modifying the request 206, and transmitting the modified request to the selected generative AI model 208. In some embodiments, process can perform step 206 before step 204.

Still referring to FIG. 2A and in greater detail, assistive service 104 receives a request 202. In some embodiments, the request can include a prompt identifying the purpose of the requested shell script. In some embodiments, request may additionally include profile information, such as an identification of the IT professional making the request, an identification of the company with which the IT professional is affiliated, or the software platform the IT professional is using to make the request. In some embodiments, the profile information may be provided as a string data structure. In other specific embodiments, the profile information may be provided as a JSON array.

As noted above, in some embodiments the profile information is an identifier may be used to access profile database 112. In some embodiments, only a single piece of profile information may be used to access profile database 112. In some embodiments, a combination of profile elements may be used to access profile database 112.

In some embodiments, assistive service 104 may use the information retrieved from the profile database 112 to select a generative AI model 108 to which to transmit the received request 204. In some embodiments, the selection is based solely on profile information included in the request. For example, assistive service 104 may always select a specific generative AI model 108 for requests identifying a particular MSP or a particular user. In other embodiments, the generative AI model 108 may be selected based on a combination of information retrieved from the profile database 112 and the telemetry database 114. For example, information retrieved from the profile database 112 may indicate that multiple generative AI models 108 are acceptable to generate the response to received prompt. In some embodiments, information retrieved from the telemetry database 114, such as cost information, recent latency information, or quality metric information, may be used to select a specific generative AI model 108 to which to transmit the prompt.

The received request may be modified 206 to augment the prompt in order to increase the likelihood that the response received from the generative AI model 108 is useful. For example, a received prompt for “optimize for battery life” may be converted into “Provide a script to optimize for battery life and comment the script for readability.” In some embodiments the “script,” generated by the generative AI model 108 in response to the request may be stored in one of the profile database 112 or the telemetry database 114 and associated with a particular IT professional, an organization with which the professional is affiliated, or an application used by the IT professional when making the request. In some embodiments, the script may be generated at the time of forming the request to be sent to the generative AI model 108 by way of questions, or a form, sent to the requestor. For example, a form may be sent to the requestor with check boxes for “Comment for readability?,” “Optimize for performance?,” “Specify target machine?,” etc. Responses to those questions may be used to assemble an augmented prompt from text snippets associated with each question.

In some embodiments, the request can be to modify an existing script for readability. The request can perform one or more of adding non-executable comments to the script, adding non-executable indentation to the script, or create a separate documentation file. In some embodiments, the text of the request can include the existing script itself. In some embodiments, user interface provides for an ability to attach the existing script. In some embodiments, the text of the request includes a reference to a local or network location of the existing script.

FIG. 2B is a flow diagram 210 illustrating example embodiments of the present disclosure. The method includes receiving a request 202, selecting a generative AI model 204, modifying the request 206, and transmitting the modified request to the selected generative AI model 208. In some embodiments, process can perform step 206 before step 204. The method further includes gathering profile information 212 from a profile database 214 and modifying the request 206 based on the gathered profile information.

In some embodiments, the profile information from the profile database 112 can be used by the assistive service 104 to modify the request sent to the generative AI mode. For example, the assistive service 104 could analyze a request such as “Optimize systems for performance,” analyze the systems deployed by the enterprise using the MSP, and after determining all of the systems are running Windows 10, modify the request to state “Optimize Windows 10 Systems for performance.” In another example, the assistive service could analyze the same request, and after determining all of the systems have at least one same hardware commonality, modify the request to include that commonality. For example, if all of the systems use 32 gigabytes of random-access memory (RAM), the request may be modified to state “Optimize systems that have 32 gigabytes of RAM for performance.” While memory is used as an example, other hardware specifications can be used such as processor type, processor speed (e.g., Gigahertz (GHz), Operations per second (OPS), floating-point operations per second (FLOPS), etc.), bus speed, video card memory, video card processor speed, video card processor type, network type, network speed, network connection type (e.g., wired ethernet, Wi-Fi, 5G, etc.), or other hardware specifications.

In some embodiments, the assistive service 104 can optionally classify the deployed systems into two or more groups of hardware or software systems 216. For example, the assistive service 104 could analyze a request such as “Optimize systems for performance,” analyze the systems deployed by the enterprise using the MSP, and after determining a first group of the systems are running Windows 10 and a second group of the systems are running Windows 11. The assistive service 104 can then generate two modified requests. A first modified request for the first group can state “Optimize Windows 10 Systems for performance,” and a second modified request for the second group can state “Optimize Windows 11 Systems for performance.” The two requests are issued separately to one or more generative AI models 108, and the response is displayed in proximity to their respective modified request.

In another example, the assistive service 104 could analyze the same request, and determine a first group of the systems have a first hardware commonality and the second group of the systems have a second hardware commonality. The assistive service 104 can generate two modified requests, one for the first group of systems and one for the second group of systems. For example, if the first group of systems use 32 gigabytes of random-access memory (RAM), the request for the first group may be modified to state “Optimize systems that have 32 gigabytes of RAM for performance.” If the second group of systems uses 64 gigabytes of RAM, the request for the second group may be modified to state “Optimize systems that have 64 gigabytes of RAM for performance.” While memory is used as an example, other hardware specifications can be used such as processor type, processor speed (e.g., Gigahertz (GHz), Operations per second (OPS), floating-point operations per second (FLOPS), etc.), bus speed, video card memory, video card processor speed, video card processor type, network type, network speed, network connection type (e.g., wired ethernet, Wi-Fi, 5G, etc.), or other hardware specifications. The two requests are issued separately to one or more generative AI models 108, and the response is displayed in proximity to their respective modified request.

FIG. 2C is a flow diagram 220 illustrating example embodiments of the present disclosure. The method includes receiving a request 202, receive selected script language 222, selecting a generative AI model 204, modifying the request 206, and transmitting the modified request to the selected generative AI model 208. In some embodiments, process can perform step 206 before step 204. In some embodiments, the selected script language 222 can include Windows® PowerShell, a Bash script, a Batch script, a Python script, or any other programming or scripting language that can be used to manage devices with a MSP.

FIG. 2D is a flow diagram 230 illustrating example embodiments of a method for enhancing the provision of information technology support services. The method includes receiving a request 202, selecting a generative AI model 204, modifying the request 206, and transmitting the modified request to the selected generative AI model 208. In some embodiments, process can perform step 206 before step 204.

In some embodiments, the method further includes receiving a script from the generative model responsive to the transmitted request 232. The method further includes presenting the script to a user via a user interface 234. The method further includes receiving feedback from a user via the user interface 238. The feedback can include an approval or disapproval of the presented script, revisions to the script within a script editor, or additional parameters to include in the request. The method then determines whether the feedback was provided 240. If no feedback is provided or the script is approved by the user, the system marks the modified request as having positive feedback for future tuning 244.

If the feedback is disapproval or other feedback, the method generates a tuned modified request based on the feedback 242. In some embodiments, telemetry database 114 stores information about the request prompt, the requesting account, the tuning used, and the response. Therefore, the telemetry database 114 provides a mechanism to allow a comparison between the response from the generative AI and the response's actual performance in the MSP. The telemetry database 114 and the data contained therein is then used for tuning analysis, A/B testing between tuning options and AI engines, and cost analysis on usage by product/partner. The modified request is transmitted to the selected model 208.

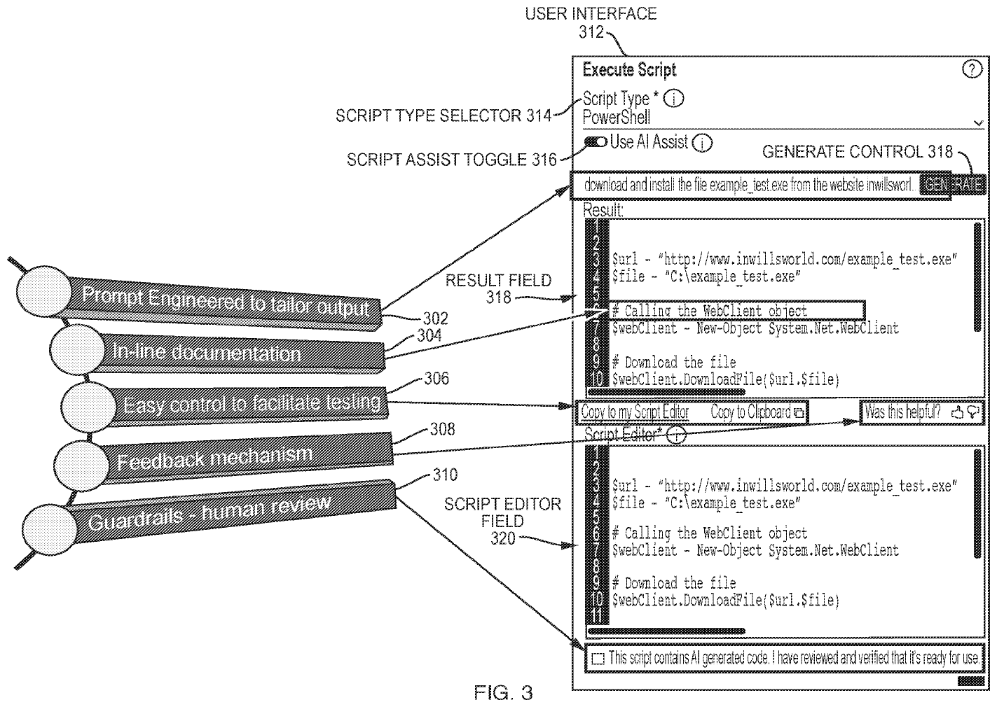

FIG. 3 is a diagram 300 illustrating some embodiments of user interface 312 employed by the present disclosure. The user interface includes a script type selector 314 that selects the scripting language desired in the output. In some embodiments, the selector 314 is optional, and the user can select the desired scripting language by directly inputting the language into their request. Optionally, the user interface 312 can further include a script assist toggle 316 (e.g., use AI assist), which when enabled automatically suggests terms for the user's request as the user types or after the user types. The script assist/AI assist 316 allows the prompt 302 to be engineered to tailor output. Prompt engineering can use the profile information as described above in relation to FIGS. 1-2.

Upon the user selecting a generate control 318, the request is sent to a selected generative AI model as described above. Upon the request being returned from the selected generative AI model, it is displayed in a result field 318 of the user interface 312. The result field 318 displays the script, and can include in-line documentation (e.g., commenting that explains the script code). The user interface 312 further includes a copy control 306 to facilitate testing. The copy control 306 copies a script editor field 320. The user can edit the script within the script editor field 320. In some embodiments, the user can select a positive or negative feedback control of feedback mechanism 308. If the user selects the negative feedback control, in some embodiments, revisions from the script editor field 320 can be used to further tune the prompt engineering. In some embodiments, a separate control can trigger user revisions to tune the prompt engineering.

In some embodiments, the user interface 312 further includes a human review control 310. The script will not run from within the user interface 312 unless the human review control 310. The human review control 310 ensures the user acknowledges that the script contains AI generated control and that they have reviewed and verified that it is ready for use.

In some embodiments, assistive system or the generative AI models can include artificial intelligence methods such as learning systems. In some embodiments, a feature vector is provided to a learning system. Based on the input features, the learning system generates one or more outputs. In some embodiments, the output of the learning system is a feature vector.

In some embodiments, the learning system comprises a SVM. In other embodiments, the learning system comprises an artificial neural network. In some embodiments, the learning system is pre-trained using training data. In some embodiments training data is retrospective data. In some embodiments, the retrospective data is stored in a data store. In some embodiments, the learning system may be additionally trained through manual curation of previously generated outputs.
In some embodiments, the learning system, is a trained classifier. In some embodiments, the trained classifier is a random decision forest. However, it will be appreciated that a variety of other classifiers are suitable for use according to the present disclosure, including linear classifiers, support vector machines (SVM), or neural networks such as recurrent neural networks (RNN).

Suitable artificial neural networks include but are not limited to a feedforward neural network, a radial basis function network, a self-organizing map, learning vector quantization, a recurrent neural network, a Hopfield network, a Boltzmann machine, an echo state network, long short term memory, a bi-directional recurrent neural network, a hierarchical recurrent neural network, a stochastic neural network, a modular neural network, an associative neural network, a deep neural network, a deep belief network, a convolutional neural networks, a convolutional deep belief network, a large memory storage and retrieval neural network, a deep Boltzmann machine, a deep stacking network, a tensor deep stacking network, a spike and slab restricted Boltzmann machine, a compound hierarchical-deep model, a deep coding network, a multilayer kernel machine, or a deep Q-network.

Artificial neural networks (ANNs) are distributed computing systems, which consist of a number of neurons interconnected through connection points called synapses. Each synapse encodes the strength of the connection between the output of one neuron and the input of another. The output of each neuron is determined by the aggregate input received from other neurons that are connected to it. Thus, the output of a given neuron is based on the outputs of connected neurons from preceding layers and the strength of the connections as determined by the synaptic weights. An ANN is trained to solve a specific problem (e.g., pattern recognition) by adjusting the weights of the synapses such that a particular class of inputs produce a desired output.

Various algorithms may be used for this learning process. Certain algorithms may be suitable for specific tasks such as image recognition, speech recognition, or language processing. Training algorithms lead to a pattern of synaptic weights that, during the learning process, converges toward an optimal solution of the given problem. Backpropagation is one suitable algorithm for supervised learning, in which a known correct output is available during the learning process. The goal of such learning is to obtain a system that generalizes to data that were not available during training.

In general, during backpropagation, the output of the network is compared to the known correct output. An n error value is calculated for each of the neurons in the output layer. The error values are propagated backwards, starting from the output layer, to determine an error value associated with each neuron. The error values correspond to each neuron's contribution to the network output. The error values are then used to update the weights. By incremental correction in this way, the network output is adjusted to conform to the training data.

When applying backpropagation, an ANN rapidly attains a high accuracy on most of the examples in a training-set. The vast majority of training time is spent trying to further increase this test accuracy. During this time, a large number of the training data examples lead to little correction, since the system has already learned to recognize those examples. While in general, ANN performance tends to improve with the size of the data set, this can be explained by the fact that larger data-sets contain more borderline examples between the different classes on which the ANN is being trained.

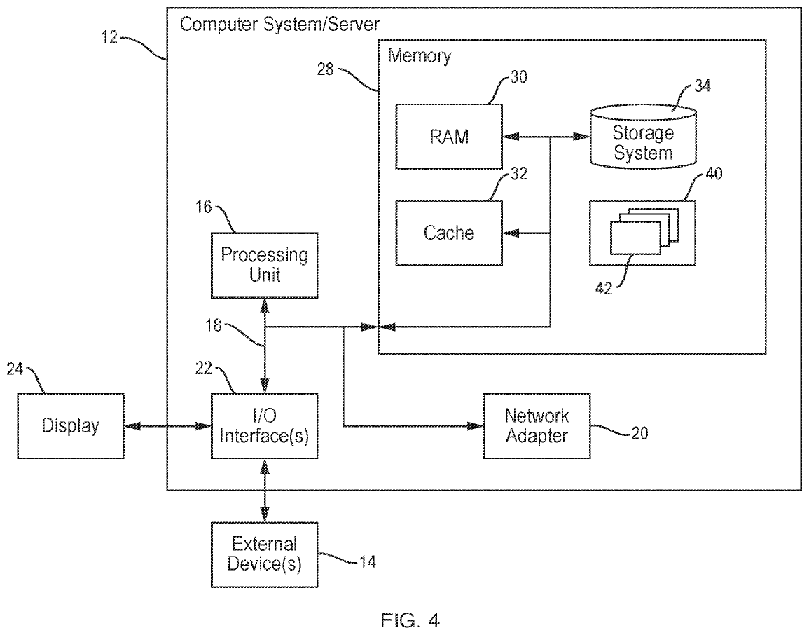

Referring now to FIG. 4, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 4, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Assistive system 104 and its components, may include hardware elements, such as one or more processors, logic devices, or circuits. For example, the system and its components may include a bus or other communication component for communicating information and a processor or processing circuit coupled to the bus for processing information. The hardware elements can also include one or more processors or processing circuits coupled to the bus for processing information. The system also includes main memory, such as a random access memory (RAM) or other dynamic storage device, coupled to the bus for storing information, and instructions to be executed by the processor. Main memory can also be used for storing position information, temporary variables, or other intermediate information during execution of instructions by the processor. The system may further include a read only memory (ROM) or other static storage device coupled to the bus for storing static information and instructions for the processor. A storage device, such as a solid state device, magnetic disk or optical disk, can be coupled to the bus for persistently storing information and instructions.

Assistive system 104 and its components, may include, e.g., computing devices, desktop computers, laptop computers, notebook computers, mobile or portable computing devices, tablet computers, smartphones, personal digital assistants, or any other computing device.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. The computer-readable programs can be implemented in a programming language, such as LISP, PERL, C, C++, C#, PROLOG, or in any byte code language such as JAVA. The software programs may be stored on or in one or more articles of manufacture as object code.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can be integrated in a single software product or packaged into multiple software products.

References to “or” may be construed as inclusive so that any terms described using “or” may indicate any of a single, more than one, and all of the described terms.

Thus, particular embodiments of the subject matter have been described. Other embodiments are within the scope of the following claims. In some cases, the actions recited in the claims can be performed in a different order and still achieve desirable results. In addition, the processes depicted in the accompanying figures may be performed in any order. In certain embodiments, multitasking and parallel processing may be advantageous.

While this specification contains many specific implementation details, these should not be construed as limitations on the scope of any subject matter of what may be claimed, but rather as descriptions of features specific to particular implementations of the subject matter. Certain features described in this specification in the context of separate embodiments can also be implemented in combination in a single embodiment. Conversely, various features described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving, at a user interface of a managed service provider, a request for an assistive service;
accessing from a memory element a profile associated with the managed service provider;
selecting, based on the accessed profile, a generative model to respond to the request;
augmenting, based on the accessed profile, the received request;
transmitting, via a network, the augmented request to the selected generative model; and
receiving, from the selected generative model, a response to the request providing the assistive service.

2. The method of claim 1, wherein augmenting the received request further includes one or more of adding, removing, and modifying a term of the received request based on the accessed profile of a user of the managed service provider.

3. The method of claim 1, wherein the accessed profile includes one or more of an identification of the user entering the request, an identification of an enterprise associated with the user, an identification of hardware deployed by the enterprise, an identification of software deployed by the enterprise, an identification of operation systems deployed by the enterprise, an identification of firmware deployed by the enterprise, and an identification of software the user is using to make the request.

4. The method of claim 1, further comprising:
classifying systems managed by the managed service provider into a first group of systems and a second group of systems, the classification based on the first group of systems having a first common hardware or software attribute and the second group of systems having a second common hardware or software attribute.

5. The method of claim 1, further comprising receiving a selected script language, the selected script language being included in the request in a manner that the generative model returns the response in the selected script language.

6. The method of claim 1, further comprising:
transmitting the augmented request to the selected generative model over a network;
receiving a script, as the result, from the generative AI model in response to the augmented request over the network;
presenting the received script in the user interface;
receiving feedback from a user via the user interface; and
upon receiving feedback indicating the augmented request should be modified, generating a tuned augmented request based on the feedback.

7. The method of claim 1, further comprising:
remotely executing instructions associated with the response at a remotely managed endpoint associated with the managed service provider.

8. A system comprising:
a computing node comprising a computer readable storage medium having program instructions embodied therewith, the program instructions executable by a processor of the computing node to cause the processor to perform a method comprising:
receiving, at a user interface of a managed service provider, a request for an assistive service;
accessing from a memory element a profile associated with the managed service provider;
selecting, based on the accessed profile, a generative model to respond to the request;
augmenting, based on the accessed profile, the received request;
transmitting, via a network, the augmented request to the selected generative model; and
receiving, from the selected generative model, a response to the request providing the assistive service.

9. The system of claim 8, wherein augmenting the received requests includes one or more of adding, removing, and modifying a term of the request based on the accessed profile of a user of the managed service provider.

10. The system of claim 8, wherein the accessed profile includes one or more of an identification of the user entering the request, an identification of an enterprise associated with the user, an identification of hardware deployed by the enterprise, an identification of software deployed by the enterprise, an identification of operation systems deployed by the enterprise, an identification of firmware deployed by the enterprise, and an identification of software the user is using to make the request.

11. The system of claim 8, wherein the program instructions further cause the processor to:
classify systems managed by the managed service provider into a first group of systems and a second group of systems, the classification based on the first group of systems having a first common hardware or software attribute and the second group of systems having a second common hardware or software attribute.

12. The system of claim 8, wherein the program instructions further cause the processor to:
receive a selected script language, the selected script language being included in the request in a manner that the generative model returns the result in the selected script language.

13. The system of claim 8, wherein the program instructions further cause the processor to:
transmit the augmented request to the selected generative model over a network;
receive a script, as the result, from the generative AI model in response to the augmented request over the network;
present the received script in the user interface;
receive feedback from a user via the user interface; and
upon feedback indicating the augmented request should be modified, generate a tuned augmented request based on the feedback.

14. The system of claim 8, wherein the program instructions further cause the processor to:
remotely execute instructions associated with the response at a remotely managed endpoint associated with the managed service provider.

15. A computer program product comprising a computer readable storage medium having program instructions embodied therewith, the program instructions executable by a server to cause the server to perform a method comprising:
receiving, at a user interface of a managed service provider, a request for an assistive service;
accessing from a memory element a profile associated with the managed service provider;
selecting, based on the accessed profile, a generative model to respond to the request;
augmenting, based on the accessed profile, the received request;
transmitting, via a network, the augmented request to the selected generative model; and
receiving, from the selected generative model, a response to the request providing the assistive service.

16. The computer program product of claim 15, wherein augmenting the received request further includes one or more of adding, removing, and modifying a term of the request based on the accessed profile of a user of the managed service provider.

17. The computer program product of claim 16, wherein the accessed profile includes one or more of an identification of the user entering the request, an identification of an enterprise associated with the user, an identification of hardware deployed by the enterprise, an identification of software deployed by the enterprise, an identification of operation systems deployed by the enterprise, an identification of firmware deployed by the enterprise, and an identification of software the user is using to make the request.

18. The computer program product of claim 15, wherein the program instructions further cause the processor to:
classify systems managed by the managed service provider into a first group of systems and a second group of systems, the classification based on the first group of systems having a first common hardware or software attribute and the second group of systems having a second common hardware or software attribute.

19. The computer program product of claim 15, wherein the program instructions further cause the processor to:
receive a selected script language, the selected script language being included in the request in a manner that the generative model returns the result in the selected script language.

20. The computer program product of claim 15, wherein the program instructions further cause the processor to:
transmit the augmented request to the selected generative model over a network;
receive a script, as the result, from the generative AI model in response to the augmented request over the network;
present the received script in the user interface;
receive feedback from a user via the user interface; and
upon feedback indicating the augmented request should be modified, generate a tuned augmented request based on the feedback.
